(19) United States
(12) Patent Application Publication
(10) Pub. No.: US 2018/0346776 A1
(43) Pub. Date: Dec. 6, 2018

(54) COMPOSITION FOR HIGH-FREQUENCY ADHESIVE SHEET FOR FOOTWEAR

(71) Applicant: Heedae Park, Busan (KR)

(72) Inventor: Heedae Park, Busan (KR)

(21) Appl. No.: 16/054,023

(22) Filed: Aug. 3, 2018

Related U.S. Application Data
(63) Continuation of application No. PCT/KR2016/001276, filed on Feb. 5, 2016.

(30) Foreign Application Priority Data
Feb. 4, 2016 (KR) 10-2016-0013955

(51) Int. Cl. C09J 175/06; C09J 175/12

(52) U.S. Cl. CPC C09J 175/06; C08L 23/0846; C09J 2205/30; C09J 175/12

(57) ABSTRACT

The purpose of the present invention is to provide a composition for improving the physical properties of a TPU high-frequency adhesive sheet to be attached to shoe uppers and, preferably, to improve a TPU high-frequency adhesive sheet that is problematic in that a high-frequency cutting operation is difficult due to the high physical properties and toughness of TPU itself, and when the physical properties are lowered in order to solve such a problem, heat resistance is also lowered therewith and thus deformation may occur in the TPU sheet during the post-processing thereof. To this end, the present invention provides a composition for a high-frequency adhesive sheet for footwear that allows a TPU high-frequency adhesive sheet to have excellent cuttability and also have improved heat resistance, wherein the TPU high-frequency adhesive sheet is manufactured by compounding an ethylene vinyl alcohol copolymer (EVOH) resin with a TPU composition and then extruding the same by a conventional T-die extrusion method.

### TECHNICAL FIELD

The present invention relates to a composition for high-frequency adhesive sheet for footwear, and more particularly to a composition for high-frequency adhesive sheet for footwear that involves compounding an ethylene vinyl alcohol (EVOH) copolymer with a normal thermoplastic polyurethane (TPU) composition in the fabrication of a high-frequency adhesive sheet to enhance the thermal resistance and high-frequency cuttability of TPU without deterioration of properties inherent to TPU.

### BACKGROUND ART

As well known in the art, a shoe upper is optionally comprised of many pieces stitched together and a printed sheet of natural leather, artificial leather, or synthetic resin in various shapes stitched onto the pieces to decorate the outer side of the shoe.

Such a shoe construction necessarily entails time-consuming stitching tasks and elaborate designs, which involves skilled sewing workers and expertise and results in a rise of the production cost with high labor cost and time-consuming tasks, eventually losing competitiveness.

A conventional method to solve this problem was adhering printed polyvinyl chloride (hereinafter, referred to as “PVC”) sheets to the shoe upper. The PVC sheets are excellent in cuttability and adhesion but increasingly excluded in use due to its adverse effects on the environment.

In recent years, many polymer materials have been introduced as alternatives to the PVC sheets causing deadly environmental contamination. Out of those alternatives, thermoplastic polyurethane (hereinafter, referred to as “TPU”) that exhibits properties most similar to those of PVC is used in the fabrication of high-frequency sheets.

As illustrated in FIG. 1, the TPU high-frequency adhesive sheet used for shoe decoration is adhered to the outer surface of an upper 2 of a shoe 1 to enhance the finish of the shoe. In a high-frequency welding machine, a sheet (specifically, TPU sheet) for making a decorative sheet 3 is cut into pieces of a desired shape with a high-frequency cutting mold, and the resultant decorative sheet 3 is adhered to the outer surface of the upper 2.

To make a decorative sheet by this method, it is necessary to cut the TPU sheet with a high-frequency cutting mold. The TPU sheet is difficult not only to cut in the high-frequency cutting operation due to high stiffness of the TPU resin but also to adhere to a specific base material (for example, woven fabric).

As a solution to this problem, the TPU composition is compounded with a rubber (e.g., SBS or SEBS) having a low thermal resistance in the production of TPU sheets for the purpose of weakening the properties of TPU, preferably enhancing the cuttability of the TPU high-frequency adhesive sheet.

This method still has many problems. It may enhance the cuttability of the TPU sheet in the production of TPU sheets with a high-frequency cutting mold, as shown in FIG. 2. But the use of rubber having a low thermal resistance leads to sagging the TPU sheet 30 at the cut-off parts during the high-frequency cutting operation and causes a need of removing the sagged parts of the TPU sheet 30 manually, while a TPU sheet 20 of a defined shape still adheres to a base sheet 10. Furthermore, the TPU sheet is prone to deform after the processing with its adhesion noticeably deteriorating when adhered to the outer surface of the upper.

### PRIOR TECHNICAL DOCUMENTS

### Patent Documents

Patent Document 1: KR Patent Laid-Open Publication No. 10-2006-0115567 (under the title of “composition for high-frequency adhesive sheet for footwear”, published on Nov. 9, 2006)

Patent Document 2: Korean Patent No. 10-1129702 (under the title of “rubber sheet for footwear with enhanced productivity and durability and its fabrication method”, registered on Mar. 28, 2012)

Patent Document 3: KR Patent Laid-Open Publication No. 10-2014-0029400 (under the title of “sheet for shoe sole and shoe sole using the same”, published on Mar. 10, 2014)

Patent Document 1: KR Patent Laid-Open Publication No. 10-2006-0001692 (under the title of “high-frequency mold for fabricating decorative sheet for footwear”, published on Jan. 6, 2006)

### DISCLOSURE

### Technical Problem

It is an object of the present invention to provide a composition for high-frequency adhesive sheet for footwear that enhances cuttability and reduces stiffness while maintaining the thermal resistance of the TPU resin in the fabrication of a TPU high-frequency adhesive sheet adhered to a shoe upper.

### Technical Solution

To achieve the object of the present invention, there is provided a composition for sheet adhered to a shoe upper through a high-frequency operation that includes thermoplastic polyurethane as a principal component and an ethylene vinyl alcohol copolymer resin.

### Advantageous Effects

The present invention is to propose a composition for enhancing the properties of a TPU high-frequency adhesive sheet to be adhered to a shoe upper. The TPU high-frequency adhesive sheet is difficult to cut by a high-frequency cutting operation due to strong properties and high stiffness inherent to the TPU resin, and weakening the properties as a solution to this problem leads to deterioration of thermal resistance, eventually deforming the TPU sheet during the processing. In an attempt to improve this problem, the present invention preferably provides a composition for high-frequency adhesive sheet for footwear that involves compounding the composition of TPU with an ethylene vinyl alcohol (EVOH) resin and then performing a normal T-die extrusion method to produce a TPU high-frequency adhesive sheet with enhanced cuttability and thermal resistance.

### BRIEF DESCRIPTION OF THE DRAWINGS

FIG. 1 is a diagram showing the construction of a normal shoe with a decorative sheet adhered to the outer surface of an upper.

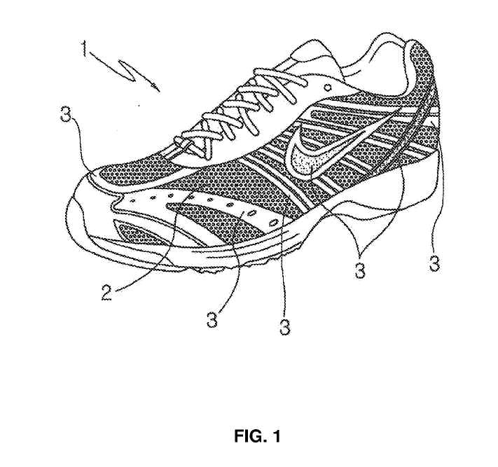

FIG. 2 is a diagram showing that a decorative TPU sheet for shoe upper according to the prior art is cut untidily and partly left uncut during the cutting process after a high-frequency welding operation.

FIG. 3 is a diagram showing that a decorative TPU sheet for shoe upper according to one embodiment of the present invention is cut neatly during the cutting process after a high-frequency welding operation.

### PREFERRED EMBODIMENTS OF THE INVENTION

Hereinafter, the embodiments of the present invention will be described with reference to the accompanying drawings as follows. The following detailed description gives one representative embodiment of the present invention for achieving the above-stated object of the present invention. The present invention is not limited to the specific embodiment disclosed as the best mode but includes all the embodiments according to the claims of the present invention.

The present invention is to provide a composition to enhance the properties of a TPU high-frequency adhesive sheet to be adhered to a shoe upper. The TPU high-frequency adhesive sheet is difficult to cut by a high-frequency cutting operation due to strong properties and high stiffness inherent to the TPU resin, and weakening the properties as a solution to this problem leads to deterioration of thermal resistance, eventually deforming the TPU sheet during the processing. In an attempt to improve this problem, the present invention preferably provides a composition for high-frequency adhesive sheet for footwear that involves compounding the composition of TPU with an ethylene vinyl alcohol (EVOH) resin and then performing a normal T-die extrusion method to produce a TPU high-frequency adhesive sheet with enhanced cuttability and thermal resistance.

When an ethylene vinyl alcohol (EVOH) resin is compound with the TPU resin in the production of a high-frequency adhesive sheet for footwear, ethylene vinyl alcohol (EVOH) enters between the molecular structures of TPU to eliminate the stiffness peculiar to the TPU resin and thus to enhance the high-frequency cuttability of the sheet. Furthermore, the use of the EVOH resin leads to no deterioration in the inherent properties of TPU but maintains the thermal resistance of the TPU sheet.

Hereinafter, a detailed description of the present invention will be given as to the preferred embodiments of the present invention, which are not intended to limit the scope of the present invention.

### Example 1

According to the present invention, a normal TPU composition and an ethylene vinyl alcohol (EVOH) copolymer are compound together in the production of a TPU high-frequency adhesive sheet. More specifically, 99 to 50 wt. % of a thermoplastic polyurethane (TPU) resin having a hardness of about 85 to 90 A and including polyester polyol and aromatic isocyanate as principal components is compound with 1 to 50 wt. % of an ethylene vinyl alcohol (EVOH) copolymer resin.

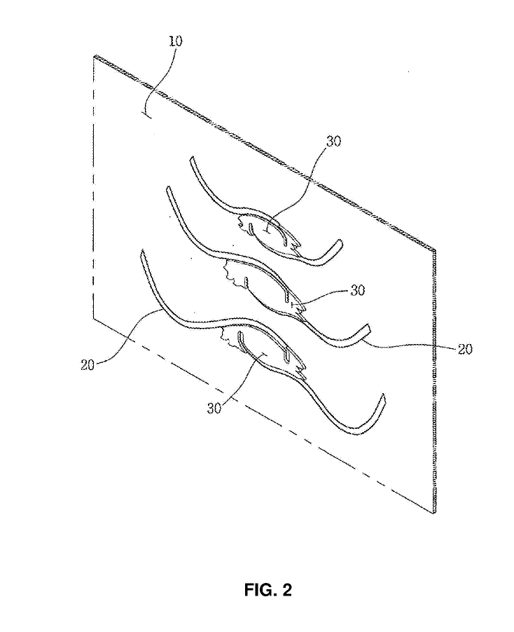

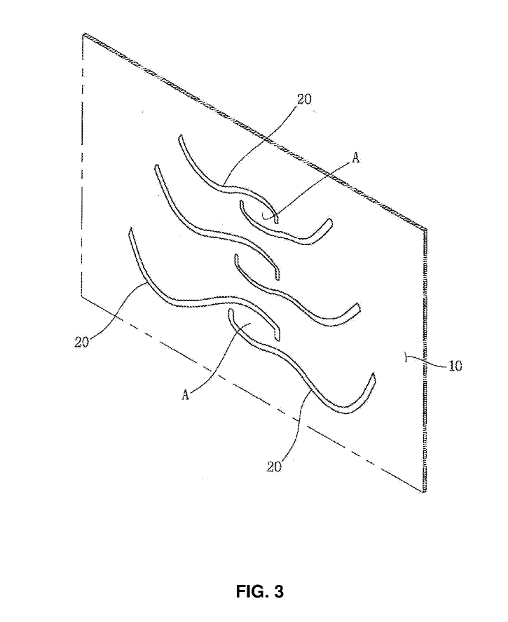

The EVOH resin used as a resin for enhancing the cuttability of the TPU high-frequency adhesive sheet reduces the stiffness of the TPU resin to make the TPU sheet easily cut at the cut portion A without remaining a residue of the TPU sheet after a high-frequency cutting operation as shown in FIG. 3, and also maintains the thermal resistance inherent to the TPU resin. In other words, the residue of the TPU sheet 30 as shown in FIG. 2 is not left on the surface of the fabric material 10.

Subsequently, the resultant composition is processed with a normal T-die extruder to produce a TPU high-frequency adhesive sheet according to the present invention.

In the TPU sheet of the present invention thus obtained, the EVOH resin enters between the molecules of the TPU resin to weaken the stiffness of the TPU resin and thus enhance the cuttability, but the thermal resistance inherent to the TPU resin is maintained, which is specifically presented in the following Table 1.

TABLE 1

| | | | Normal | | Novel | |
|---|---|---|---|---|---|---|
| | Measurement method | | TPU | Prior art | TPU | |
| Div. | Standards | Unit | sheet | TPU sheet | sheet | Ref. |
| T-90A | Normal TPU resin | | 100% | 75% | 90% | |
| | for extrusion | | | | | |
| SEBS 655 | Rubber resin for | | | 25% | | |
| | improving cuttability | | | | | |
| EVAL | EVOH resin for | | | | 10% | |
| C109B | improving cuttability | | | | | |
| Thickness | | mm | 0.7 | 0.7 | 0.7 | |
| Hardness | ASTM | Shore | 88 ± 2 | 85 ± 2 | 88 ± 2 | |
| | D 2240 | A | | | | |
| Tensile | ASTM | Kg/ | Min 300 | Min 200 | Min 200 | |
| strength | D 412 | cm² | | | | |
| Elongation | ASTM | % | Min 500 | Min 500 | Min 500 | |
| | D 412 | | | | | |
| Tear | ASTM | Kg/cm | Min 80 | Min 70 | Min 80 | |
| strength | D 628 | | | | | |
| Melt flow | ASTM | g/10 | 10-20 | 20-30 | 10-20 | |
| index | D 1238 | min | | | | |
| Melting | ASTM | ° C. | 150-160 | 140-150 | 150-160 | DSC |
| temperature | D 3418 | | | | | |
| (Tm) | | | | | | |
| HF | 100-110° C./ | | Not | Cut easily, | Nicely | |
| cuttability | 0.4 A | | cut | with | cut | |
| | current/ | | easily | sagging | | |
| | 4-5 kg/cm² | | | untidy | | |
| | pressure | | | cross- | | |
| | | | | section | | |

As can be seen from Table 1, the prior art TPU sheet using rubber to improve cuttability displays a reduction of the hardness and the melting temperature (Tm), acquiring improved cuttability, but has the cut-off surface untidy with sagging caused by the deteriorated thermal resistance after the cutting operation. By contrast, the novel TPU sheet using an EVOH resin to improve cuttability still has neither a change in the hardness and the melting temperature (Tm) nor a deterioration of the thermal resistance of the TPU resin, thereby acquiring good cuttability without sagging.

In the diagrams of FIGS. 2 and 3, the conditions of the high-frequency cutting operation for the TPU sheet include a temperature of 100 to 110° C., a current of 0.4 A, and a pressure of 4 to 5 kg/cm².

### INDUSTRIAL APPLICABILITY

The present invention involves compounding a thermoplastic polyurethane (TPU) composition with an ethylene vinyl alcohol (EVOH) copolymer in the production of a TPU high-frequency adhesive sheet to enhance the cuttability during the high-frequency cutting operation by reducing the stiffness of the TPU sheet and to maintain the thermal resistance inherent to the TPU resin.

What is claimed is:

1. A composition for high-frequency adhesive sheet for footwear, which composition comprises thermoplastic polyurethane as a principal component and is used for a sheet adhered to an upper of footwear by a high-frequency operation,
the composition comprising an ethylene vinyl alcohol copolymer resin.

2. The composition for high-frequency adhesive sheet for footwear as claimed in claim 1, wherein the thermoplastic polyurethane comprises polyester polyol and aromatic isocyanate as principal components and has a hardness of 85 to 90 A,
the composition comprising 99 to 50 wt. % of the thermoplastic polyurethane and 1 to 50 wt. % of the ethylene vinyl alcohol copolymer resin.
